(19) United States
(12) Patent Application Publication
(10) Pub. No.: US 2020/0239350 A1
(43) Pub. Date: Jul. 30, 2020

(54) DEVICE AND PROCESS FOR PRODUCING A GLASS PRODUCT AND GLASS PRODUCT

(71) Applicant: SCHOTT AG, Mainz (DE)

(72) Inventors: Wolfgang Schmidbauer, Mainz (DE); Markus Haberkorn, Waldsassen (DE); Andreas Koehler, Neualbenreuth (DE); Andreas Bensberg, Mainz (DE); Christoph Bergmann, Hannover (DE); Volker Trinks, Mitterteich (DE); Rainer Eichholz, Frankfurt (DE); Michael Hahn, Hohenstein (DE); Holger Wegener, Alfeld, (DE); Rainer Schwertfeger, Eschershausen (DE)

(73) Assignee: SCHOTT AG, Mainz (DE)

(21) Appl. No.: 16/776,782

(22) Filed: Jan. 30, 2020

(30) Foreign Application Priority Data
Jan. 30, 2019 (DE) 10 2019 102 307.6

(51) Int. Cl. C03B 15/14; C03B 35/26

(52) U.S. Cl. CPC C03B 15/14; C03B 35/26

(57) ABSTRACT

A method for producing a glass product is provided. The method includes providing a glass melt; hot forming the glass melt to obtain a glass product; and transferring the glass melt from a first region to a second region through a tube. The tube has a part that protrudes with a length into the glass melt in the first region. The part being at a distance from an inner base lying directly thereunder. The length and the distance are configured so that little defective glass gets into the tube and is transferred to the second region.

### CROSS REFERENCE TO RELATED APPLICATIONS

This application claims benefit under 35 USC X119 of German Application No. 10 2019 102 307.6 filed Jan. 30, 2019, the entire contents of which are incorporated herein by reference.

### BACKGROUND

### 1. Field of the Invention

The disclosure relates generally to a device for producing a glass product and to a process for producing a glass product and to a glass product that is produced or can be produced in such a way.

### 2. Description of Related Art

It is known that high-quality glass products may contain defects in the form of solid glass, which are also referred to as knots.

Various mechanisms of knot formation are known. For example, it is possible that knots are stone defects, that is to say for example parts of the batch that have only melted insufficiently. The main cause of this is the insufficient dissolving of SiO₂ particles, which in the further course of the melting process are surrounded with a dissolution halo. A characteristic indication of such a knot is often a visible agglomeration of particles of the batch at the centre. Much more frequent, however, is the mechanism that knots are created from the partially melted refractory material of a melting device and/or also from the superficial defective glass of a glass synthesis tending towards evaporation. Such knots may sometimes be formed as so-called “transparent knots”. A transparent knot should be understood here as meaning that the knot consists of completely melted glassy or at least glass-like material. As a difference from this, a non-transparent knot is a knot which comprises molten glassy or at least glass-like material, in the centre of which there is however additionally a solid particle, which may for example consist of recrystallized SiO₂ or of undissolved or not yet dissolved refractory material.

In the context of the present disclosure, the glass comprising knots and/or glass forming the knot is referred to as defective glass, irrespective of the exact composition and the exact creation of this glass. Defective glass that results for example from the evaporation of readily volatile substances on the surface of a glass melt is also referred to as evaporation defective glass. In the context of the present disclosure, defective glass that is created for example by the corrosion of the refractory material by the glass melt of the starting glass is referred to as corrosion defective glass or as refractory defective glass. In the context of the present disclosure, knots, which are also referred to as “tank drops”, “crown drops” or “furnace drops”, are generally understood as meaning, irrespective of the precise nature of their creation, at least partially glass-like or glassy and at least highly viscous, often SiO₂-rich, defects in the glass. These knots may for example be accompanied by a so-called dissolution halo or filamentary stria. In the extreme form of dissolving, a mostly SiO₂-containing and/or SiO₂-enriched stria results.

With regard to the composition of such at least partially glassy and/or glass-like and at least highly viscous defects, a broad distinction can be made between two groups. The first group of knots has a composition that corresponds approximately to that of an evaporation defective glass. In the context of the present disclosure, an evaporation defective glass is understood as meaning a glass which is created by evaporation of volatile substances, such as for example sodium borate and/or boric acid, from the synthesis of the base glass. These are therefore at least highly viscous, in the extreme case even solid, glass defects, which may in particular be created at the surface of a glass melt, but also at boundary surfaces below the surface of the glass bath that are subject to a free exchange of gas. The second group of knots comprises in particular those at least highly viscous and in the extreme case even solid glass bodies of a composition that suggests that the glass defect is produced by the interaction between refractory material and the glass melt.

In the context of the present disclosure, a distinction is made between glass knots that have a composition of an evaporation defective glass and are also referred to in the context of the present disclosure as “evaporation knots”, and the knots that result from the corrosion of the refractory material, that is to say a refractory defective glass, and are also referred to in the context of the present disclosure as refractory knots (RK).

Both the evaporation knots and the refractory knots have a characteristic, non-steady progression in their defect density. With the procedure of the production process otherwise remaining the same, it may therefore happen that phases of great freedom from defects may be spontaneously interrupted by phases with a high occurrence of defects. These fluctuations can be observed both in a short time sequence of several minutes, but also over a longer time period of weeks and months. The knot density may in this case assume values of several 1000 knots/kg of glass, such a high knot density also possibly continuing over a course of several weeks. This means a very great loss of production.

Devices for producing glass products are described for example in U.S. Pat. Nos. 3,450,653, 7,017,372 B2, US 2017/0050874 A1, US 2014/366583 A1, U.S. Pat. Nos. 5,655,434 B2, 5,609,661 B, SU 1318553, U.S. Pat. Nos. 2,866,383, 2,808,446, SU 977410, U.S. Pat. Nos. 3,676,099, 4,662,927, 5,078,777, 4,424,071, DE 10141858, U.S. Pat. Nos. 10,208,535, 6,227,007, 4,365,987, 4,388,721, JP 2013/193905 A, JP 2013/193906, WO 2007/078875, U.S. Pat. Nos. 4,029,887, 3,266,881 and 2,691,689. However, they do not address the reduction of glass defects caused by knots.

Measures for preventing knots are generally additional internal fittings or geometrical modifications in the region of the trough or the use of stirrers, either with the intention of preventing further flow of knot-containing glass (that is to say defective glass) or with the intention of diverting the knot-containing glass (defective glass) away from the defect-free glass (good glass). These modifications to the construction of a device for producing a glass product do however generally entail considerable expenditure and/or are not sufficiently effective in avoiding knots.

The European patent application EP 1 285 886 A2 for example describes a method and an apparatus for producing a glass melt. The apparatus is formed such that bypasses of the glass stream from the surface to the outlet opening in a melting aggregate or in a melting tank shall be avoided so that as possible all melting particles have the same retention time in the melting tank.

The method and the apparatus according to EP 1 285 886 A2 are based on the idea that knots or knot glass prevalently are formed at the glass surface and represent not completely fused agglomerations of particles. These knots could accordingly be minimized by avoiding that material remaining in the melting tank for a short period only is transferred out of the melting tank into other regions of an apparatus for producing glass. In this context, various measure are proposed in EP 1 285 886 A2, in order to increase the retention period for all components in the melting tank: A cover may be provided over the outlet, or A tube may be provided, which is arranged in a certain distance above the tank bottom and for example extends into the melt, for half a meter, or An additional heating may be provided in the region of the outlet, by which heating the glass stream, being a convection current indeed, in the melting tank changes direction and thereby avoids bypasses.

However, it became apparent that also the solutions proposed in EP 1 285 866 A2 are not sufficient for avoiding knots.

According to the understanding EP 1 285 866 A2 is based on, the origin of the knots is in the surface layer of a melting tank, therefore in the region of an apparatus for producing a glass product, in which region fusing an agglomeration, if applicable also refining the fused agglomeration, takes place. This, however, is not completely correct. Knots rather may originate also and in particular by depositing the tank material, as has been described above.

Knots also originate not only in a region of an apparatus for producing a glass product in which region the agglomeration is fused. It rather is apparent that also in other regions of such an apparatus, for example in the region for refining (also referred to as working tank), knots may originate or occur.

Furthermore, the effective melting volume is very highly decreased by means of an extension of a tube of a length of half a meter or more, which tube is additionally arranged in a certain distance to the bottom of a melting tank.

Overall, the solutions provided in the state of the art therefore are not sufficient to avoid knots in a glass product or to at least reduce their occurrence.

There is consequently a need for a device and a process that at least mitigate the weaknesses of the prior art, in particular the occurrence of knots.

### SUMMARY

The object of the invention is that of providing a device and a process for producing a glass product that at least mitigate the aforementioned weaknesses of the prior art, in particular a process for producing a glass product that can more easily be further processed, in particular a process for producing a glass product that prevents or at least reduces the occurrence of knots in a glass product. A further aspect of the present invention is to provide a glass product that, as a half-finished product, can more easily be further processed.

Thus, the present disclosure relates to a device for producing a glass product, a method of producing a glass product, and the glass products produced therefrom.

A method for producing a glass product is provided. The method includes providing a glass melt; hot forming the glass melt to obtain a glass product; and transferring the glass melt from a first region to a second region through a tube. The tube has a part that protrudes with a length into the glass melt in the first region. The part being at a distance from an inner base lying directly thereunder. The length and the distance are configured so that little defective glass gets into the tube and is transferred to the second region.

In some embodiments either alone or together with any one or more of the aforementioned and/or after-mentioned embodiments, the method further includes transferring the glass melt from the second region to a third region through another tube having a part that protrudes with a length into the glass melt in the second region. The part being at a distance from an inner base lying directly thereunder. The length and the distance are configured so that little defective glass gets into the tube and is transferred to the third region.

In some embodiments either alone or together with any one or more of the aforementioned and/or after-mentioned embodiments, the method further includes transferring the glass melt from the third region to a fourth region through yet another tube having a part that protrudes with a length into the glass melt in the third region. The part being at a distance from an inner base lying directly thereunder. The length and the distance are configured so that little defective glass gets into the tube and is transferred to the fourth region.

In some embodiments either alone or together with any one or more of the aforementioned and/or after-mentioned embodiments, the step of providing the glass melt is a step selected from a group consisting of melting, fusing, refining, conditioning, and any combinations thereof.

In some embodiments either alone or together with any one or more of the aforementioned and/or after-mentioned embodiments, the step of providing the glass melt includes melting and/or fusing the glass melt in the first region.

In some embodiments either alone or together with any one or more of the aforementioned and/or after-mentioned embodiments, the second region is a region configured to treat the glass melt by a process selected from a group consisting of refining, conditioning, the step of hot forming, and any combination thereof.

In some embodiments either alone or together with any one or more of the aforementioned and/or after-mentioned embodiments, the step of providing the glass melt includes refining in the first region.

In some embodiments either alone or together with any one or more of the aforementioned and/or after-mentioned embodiments, the second region is a region configured to treat the glass melt by a process selected from a group consisting of conditioning, the step of hot forming, and any combination thereof.

In some embodiments either alone or together with any one or more of the aforementioned and/or after-mentioned embodiments, the second region is a region for the step of hot forming.

In some embodiments either alone or together with any one or more of the aforementioned and/or after-mentioned embodiments, the method further includes drawing off an accumulated deposition of the defective glass from the glass melt from a drain in the inner base. The drain is underneath the part.

In some embodiments either alone or together with any one or more of the aforementioned and/or after-mentioned embodiments, the step of hot forming the glass melt to obtain the glass product includes drawing a glass rod or glass tube using a process selected from a group consisting of a Vello process, a Danner process, and a draw-down process.

In some embodiments either alone or together with any one or more of the aforementioned and/or after-mentioned embodiments, the method further includes configuring the length of the part to be at least 25 mm.

In some embodiments either alone or together with any one or more of the aforementioned and/or after-mentioned embodiments, the method further includes configuring the length of the part to be at least as great as an average outside diameter of a cross section of the tube.

In some embodiments either alone or together with any one or more of the aforementioned and/or after-mentioned embodiments, the method further includes configuring the length of the part to be at most 500 mm.

In some embodiments either alone or together with any one or more of the aforementioned and/or after-mentioned embodiments, the method further includes configuring the distance to be at least 50 mm.

In some embodiments either alone or together with any one or more of the aforementioned and/or after-mentioned embodiments, the method further includes configuring the distance to be at least greater by a factor of 1.5 than an average outside diameter of a cross section of the tube.

In some embodiments either alone or together with any one or more of the aforementioned and/or after-mentioned embodiments, the method further includes configuring the distance to be at most a depth of a bath of the glass melt less 1.5 times an outside diameter of a cross section of the tube.

In some embodiments either alone or together with any one or more of the aforementioned and/or after-mentioned embodiments, the method further includes configuring the tube so that an average inside diameter tapers in a direction of flow of the glass melt from the first region to the second region.

In some embodiments either alone or together with any one or more of the aforementioned and/or after-mentioned embodiments, the method further includes configuring the tube as a refractory material and/or a refractory metal at least in an area that is in direct contact with the glass melt.

In some embodiments either alone or together with any one or more of the aforementioned and/or after-mentioned embodiments, the step of transferring through the tube is sufficient so that the glass product comprises no knots with a diameter of more than 1.5 mm per pallet of glass.

In some embodiments either alone or together with any one or more of the aforementioned and/or after-mentioned embodiments, the step of transferring through the tube is sufficient so that the glass product comprises no knots with a diameter of more than 0.8 mm per pallet of glass.

In some embodiments either alone or together with any one or more of the aforementioned and/or after-mentioned embodiments, the step of transferring through the tube is sufficient so that the glass product comprises less than 3.4 knots per kilogram of glass with a diameter of more than 0.5 mm and at most 0.8 mm.

In some embodiments either alone or together with any one or more of the aforementioned and/or after-mentioned embodiments, the step of transferring through the tube is sufficient so that the glass product comprises less than 3 knots per kilogram of glass with a diameter of more than 0.5 mm and at most 0.8 mm.

### BRIEF DESCRIPTION OF THE DRAWINGS

The invention is further explained below on the basis of drawings, in which:

FIGS. 1 to 4 show schematic and not-to-scale representations of a part of a device according to embodiments of the invention,

FIG. 5 shows a schematic and not-to-scale representation of a transfer device in a side wall of an embodiment of a device,

FIG. 6 shows a diagrammatic representation of the defective glass in a device for producing a glass product in the case of various embodiments of a transfer device, and

FIG. 7 shows a schematic presentation of a knot in a glass product.

### DETAILED DESCRIPTION

The disclosure relates to a device for producing a glass product, comprising: a region for melting, in particular fusing, a glass melt; in particular a region for refining a glass melt; in particular a region for conditioning a glass melt; a region for hot forming a glass melt to obtain a glass product and at least one transfer device, formed as a tube, by which the glass melt can be transferred from one region of the device into another region of the device, the tube being formed such that a part of the tube protrudes through a side wall of a region into the glass melt, the length of the protruding part, that is to say the part of the tube that protrudes within the region concerned into the glass melt, being chosen such that the part of the tube protrudes to such an extent that little defective glass gets into the tube and is transferred into another region of the device. The length of the protruding part of the tube is preferably at least 25 mm, particularly preferably at least 50 mm, and most particularly preferably at least as great as the average outside diameter of the tube cross section, and is preferably at most 500 mm.

The protruding part of the tube is in this case at a distance from the inner base lying directly thereunder of the device in this region, by a distance which is at least so great that little defective glass gets into the tube and is transferred into another region of the device, the distance preferably being at least 50 mm, and particularly preferably at least greater by a factor of 1.5 than the average outside diameter of the tube cross section, the distance preferably being at most the depth of the glass bath less 1.5 times the outside diameter of the tube cross section from the inner base of the region of the device.

In particular, the present disclosure relates to a device comprising a region for melting, in particular fusing, a glass melt, in particular a region for refining a glass melt, a region for conditioning a glass melt, a region for hot forming a glass melt to obtain a glass product and at least one transfer device, formed as a tube, by which the glass melt can be transferred from the region of the device for conditioning into the region of the device for hot forming, the tube being formed such that a part of the tube protrudes through a side wall of a region into the glass melt, the length of the protruding part being chosen such that the part of the tube protrudes into the region of the device for conditioning to such an extent that little defective glass gets into the tube and is transferred into the region of the device for hot forming, wherein the length of the protruding part of the tube is preferably at least 25 mm, particularly preferably at least 50 mm, and most particularly preferably at least as great as the average outside diameter of the tube cross section, and is preferably at most 500 mm, and wherein the protruding part of the tube is at a distance from the inner base lying directly thereunder of the device in the region of the device for conditioning, by a distance which is at least so great that little defective glass gets into the tube and is transferred into the region of the device for hot forming, the distance preferably being at least 50 mm, and particularly preferably at least greater by a factor of 1.5 than the average outside diameter of the tube cross section, the distance preferably being at most the depth of the glass bath less 1.5 times the outside diameter of the tube cross section from the inner base of the region of the device.

Alternatively or additionally, the device may be designed comprising a region for melting, in particular fusing, a glass melt, in particular a region for refining a glass melt, in particular a region for conditioning a glass melt, a region for hot forming a glass melt to obtain a glass product and at least one transfer device, formed as a tube, by which the glass melt can be transferred from a first region of the device into another region of the device, the tube being formed such that a part of the tube protrudes through a side wall of a region into the glass melt, wherein the length of the protruding part of the tube is at least 25 mm, preferably at least 50 mm, and particularly preferably at least as great as the average outside diameter of the tube cross section, and is preferably at most 500 mm, and wherein the protruding part of the tube is at a distance from the inner base lying directly thereunder of the device in this region, by a distance, the distance being at least 50 mm, and preferably at least greater by a factor of 1.5 than the average outside diameter of the tube cross section, the distance preferably being at most the depth of the glass bath less 1.5 times the outside diameter of the tube cross section from the inner base of the region of the device.

Such a configuration of a device for producing a glass product has a series of advantages.

For example, with regard to the so-called evaporation knots, it has been established that the evaporation defective glass forming these evaporation knots has at the melting temperature a higher density and a higher viscosity than the base glass forming the actual glass melt. This is all the more surprising since at room temperature the evaporation defective glass has a lower density than the base glass.

It has also been established that, in spite of a great rate of evaporation at the surface of the glass melt, there is only a very thin layer of evaporation defective glass on the surface of the melt bath. This means that the evaporation defective glass therefore does not build up on the surface of the melt bath to form a thick layer.

Rather, the evaporation defective glass formed on the surface of the melt bath moves with the flow of the surface towards the walls bounding the device and forms there a coating film of knot glass. On account of its higher density in comparison with the base glass melt, this coating film moves downwards on the wall of the device towards the inner base of the device. It has been found that this film can have a thickness of several millimetres. At the bottom of the device for producing a glass product, that is to say for example at the bottom of a so-called melting tank, there forms as a result of this downward flow a deposition of evaporation defective glass in the form of a bottom layer in a region of a device for producing a glass product, such as for example a melting basin.

This deposition of defective glass can therefore be understood as glass that differs in its composition from that of the base glass and has been created for example as a residue of the base glass resulting for example from an evaporation process.

Refractory corrosion, that is to say corrosion of the refractory material, can be understood as the second process of knot formation. In the context of the present disclosure, refractory materials is the term used here for ceramic materials that have a high temperature resistance, in particular a temperature resistance of more than 1000° C. Such materials are used for example in devices for melting glass and are for example also referred to as tank blocks.

Refractory corrosion refers here to the reaction of the refractory material with the materials surrounding the refractory material, here therefore in particular the reaction of the refractory material with a glass melt. As a consequence of this reaction, there may be a breakdown of the refractory material. In particular, a reaction layer forms between the glass melt—for example also the evaporation defective glass melt—and the refractory material. This may involve a discharge of solid particles from the refractory material. This discharge, that is to say the particles detached from the refractory assembly, typically likewise have a higher density than the base glass and likewise move downwards on the wall of the device. The particles discharged from the refractory material may likewise be at least partially dissolved and/or in a glassy state of transformation and are likewise referred to in the context of the present disclosure as knots, that is to say as at least highly viscous and at least partially glass-like or glassy glass defects. This glassy or at least glass-like material is also referred to as refractory defective glass.

In the device for producing a glass product, a deposition in the form of a bottom layer consequently forms in the device for producing a glass product, such as for example a melting basin, that is to say a region within the device which comprises defective glass, such as for example evaporation defective glass and/or corroded, in particular at least partially glassy and/or glass-like refractory material, that is to say refractory defective glass. This region is generally arranged at the bottom of the device for producing a glass product, for example at the bottom of a melting unit, such as a melting tank.

In the context of the present disclosure, a defective glass is therefore understood as meaning a glass that deviates in its composition from the composition of the base glass, that is to say of the glass of a desired composition that is addressed for the production of the glass product. In a narrower sense, it may also be understood as meaning that it is not only glass of a composition deviating from the desired glass composition to be produced but also a glass that leads to the formation of glass defects in the resultant glass product in the glass production process, for example on account of the deviating composition. A special form of the defective glass is therefore in particular the knot glass, which not only has a composition deviating from the composition of the glass actually addressed and to be produced but also leads to the formation of knots as glass defects in the glass product.

In the context of the present disclosure, to differentiate from the defective glass, the glass actually addressed and to be produced is also referred to as good glass.

In the region of the bottom layer there forms the deposition. Here it is a material that forms or can form as a residue of the production process for a glass product, in particular in the bottom region of a device for producing a glass product, for example therefore at the bottom of a melting tank. Apart from defective glass, for example knot glass, the deposition may also comprise further constituents, for example unmelted residues of the batch.

Generally, the deposition in a device for producing a glass product, such as a melting tank, consists of a mixture of evaporation defective glass and corrosion products of the refractory material, that is to say refractory defective glass. However, this deposition may also be formed only from corroded refractory material, that is to say the refractory defective glass, without the process of evaporation and the correspondingly resultant creation of evaporation defective glass. Which composition the deposition has, and whether for example evaporation defective glass is formed, depends here in particular on the composition of the base glass.

Glass melts that are particularly aggressive, and therefore tend in particular to the formation of knots or comprising refractory defective glass, are for example alkali-free glasses. Glass melts that are in particular susceptible to evaporation, and therefore particularly tend to the formation of evaporation defective glass, are in particular glasses comprising boron, such as for example borosilicate glasses.

Devices for producing a glass product are formed such that the glass, for example in molten form, can pass from one region of the device into another. In particular, such a device therefore comprises at least one transfer device.

If the device is therefore formed such that the transfer device, which may for example be formed as a removal opening, that is to say may for example be arranged in the region in which the glass melt is led out of the melting unit itself into the region of the hot forming, is very close to the refractory boundary of the melting unit, then for example the downward-flowing wall layer of evaporation defective glass and refractory defective glass is entrained into the transfer device. As a consequence, solid or highly viscous glass defects, that is to say knots, are created. These can no longer be dissolved into the base glass even in the further melting process.

According to the present disclosure, this transfer device therefore takes the form of a tube. By this forming of the transfer device as a tube, the intake of streams of highly viscous knot glass is deliberately avoided or at least reduced.

In order to achieve this, however, the tube must protrude by a certain minimum length into the glass melt. It is also necessary that the transfer device in the form of a tube maintains a certain minimum distance from the bottom.

This is necessary in order that the transfer device also protrudes into the region of the glass melt in which the glass melt has the composition of the base glass, that is to say into the region that lies outside the flow of knot glass. Furthermore, the minimum distance from the inner base of the device for producing a glass product is necessary in order to remain above the bottom layer comprising the deposition, that is to say above the region of the device in which there is a glass melt of a chemical composition that differs from the base glass.

This is achieved according to the present disclosure in a first case in that the length of the part of the tube that protrudes into the glass melt is chosen such that the part of the tube protrudes into the region to such an extent that little defective glass gets into the tube and is transferred into another region of the device, the length of the part of the tube preferably being at least 25 mm, particularly preferably at least 50 mm, and most particularly preferably at least as great as the average outside diameter of the tube cross section, and preferably being at most 500 mm.

This is also achieved according to the present disclosure in that the part of the tube that protrudes into the region concerned of the device for producing a glass product is at a distance from the inner base lying directly thereunder of the device in this region, preferably by a distance of at least 50 mm, preferably by a distance that is at least greater by a factor of 1.5 than the average outside diameter of the tube cross section, the distance preferably being at most the depth of the glass bath less 1.5 times the outside diameter of the tube cross section from the inner base of the region concerned of the device.

According to this first case, the transfer device furthermore is arranged such that it transfers glass from the region of the device for conditioning into the region of the device for hot forming.

Up to now, this has not been provided in prior art. Since, in prior art, as stated above, one assumed that just the region for melting a glass melt is the origin of knots.

This means that this protrusion of the transfer device formed as a tube, between the region of the device for conditioning according to the first case, is an essential aspect of the device according to the present disclosure.

This is so because it is only by a sufficient protrusion at a sufficient height of the side wall, also and just between the region of the device for conditioning (also referred to as “working tank”) and the region of the device for hot forming, that it can be ensured that the ingress of knot glass, and consequently the production of glass defects in the glass product as a result of knots, through the transfer device from one region of a device for producing a glass product into another region of this device, that is to say for example from one region of a glass melting unit into another region of this unit, namely here according to the first case of the invention from the region of the device for conditioning into the region of the device for hot forming, is ruled out or at least reduced.

If, however, the protrusion is too short and/or not arranged sufficiently high up on the side wall, either the ingress of the knot glass is not reliably prevented and/or the surrounding of the tube is very badly corroded on account of a parasitic secondary flow of the glass melt.

According to the second case of the present disclosure, a reduction of knots in a glass product is accordingly achieved in that the length of the part of the tube, protruding into the glass melt, is chosen such that the part of the tube protrudes into the region to such an extent that little defective glass gets into the tube and is transferred into another region of the device, wherein the length of the protruding part of the tube is preferably at least 25 mm, particularly preferably at least 50 mm, and most particularly preferably at least as great as the average outside diameter of the tube cross section, and is preferably at most 500 mm and the part of the tube, protruding into the concerning region of the device for producing a glass product, is at a distance from the inner base lying directly thereunder of the device in that region by a distance being at least 50 mm, and preferably at least greater by a factor of 1.5 than the average outside diameter of the tube cross section, the distance preferably being at most the depth of the glass bath less 1.5 times the outside diameter of the tube cross section from the inner base of the region of the device.

That means that an essential aspect according to the second case has to be seen just in the combination of the features of a certain, but finally not too large, but maximally 500 mm long protrusion of a tube in a certain height of a side wall. Because in that case, the effective melting volume is not too highly reduced. Sucking in a skin layer of defective glass by means of the upward stream at the side wall is at least reduced, if not avoided, at all. Simultaneously, it is also possible with such an arrangement to choose quite large tube diameters. By doing so, a high transfer efficiency is ensured, at the same time.

For example, the height, in which the tube is mounted, may be between 150 mm and 750 mm, for an outer diameter of 100 mm of a tube. The length of the protruding part is up to 150 mm, and therefore is essentially less than according to prior art. Such a combination of features is not provided, according to prior art. Because according to prior art, one had to assume that a very large protrusion is necessary. Furthermore, the tube should be arranged in the bottom region, as possible.

In the context of the present disclosure, the average outside diameter of the tube cross section describes the dimensions of the tube in the two spatial directions of a system of Cartesian coordinates that are arranged perpendicularly to the greatest lateral dimension of the tube, that is to say perpendicularly to the length of the tube.

According to the present disclosure, the tube may have a cross section of almost any desired form, that is to say for example a round, oval, angular and/or pitched roof-shaped cross section. Furthermore, it is also possible that the outer cross section of the tube differs from the inner cross section, that is to say for example the outer outlines of the tube assume the form of a triangle, but the inner cross section of the tube, that is to say the part of the tube through which the glass melt actually passes from one region of the device for producing a glass product into another region of the device, has a round cross section.

If the tube has an outer cross section deviating from a circular form, in the context of the present disclosure the average outside diameter of the tube cross section describes the diameter which corresponds to the diameter of a circle with an identical outer cross sectional area of the tube. Furthermore, the length of the circumscribing principal axes of the chosen structural form is not intended to differ by more than a factor of 2.

It has been found that knot glass is formed in a device for producing a glass product in particular in the region for refining a glass melt and the region for conditioning a glass melt.

According to one embodiment of the device the tube is arranged in a side wall of the device between the region for refining and the region for conditioning the glass melt, a part of the tube protruding into the region for refining, so that glass melt is transferred or can be transferred from the region for refining into the region for conditioning, and/or the tube is arranged in a side wall of the device between the region for conditioning and the region for hot forming the glass melt, so that glass melt is transferred or can be transferred from the region for conditioning into the region for hot forming, the protruding part of the tube protruding through the side wall of the device into the respective region of the device for refining and/or conditioning.

By this spatial configuration of the device, in particular therefore the arrangement of the transfer device in the form of a tube between certain regions of the device, the transfer of knot-like glass defects into the glass product can be reduced in a particularly efficient way.

According to a further embodiment of the device for producing a glass product, the tube is formed such that the average inside diameter of the tube cross section tapers in the direction of flow of the glass melt.

Such a configuration of the device for producing a glass product is advantageous because in this way conversion or maintenance measures can be performed more easily on the device. In particular, with such a configuration of the tube with a cross section tapering in the direction of flow of the glass melt, forcing out of the solidified glass gob can be avoided when there is a change of trough and/or when there is a change of other components, for example components of a melting unit that comprise noble metal.

According to a further embodiment of the device for producing a glass product, the tube comprises a refractory material and/or a noble metal and/or a refractory metal.

In the context of the present disclosure, a refractory metal is understood as meaning an ignoble metal that is stable at high temperature. Examples of such refractory metals are for example tungsten, or molybdenum. In the context of the present disclosure, stable at high temperature is the term used for a metal that has a melting point of more than 2000° C.

If the tube consists of refractory material or a refractory metal which is not permanently stable with respect to corrosion by the glass melt, at least the part that is in direct contact with the glass melt, preferably the entire tube, is enclosed with a material comprising noble metal. The enclosure in this case comprises not only the outer side, but also the end face and the inner side of the tube. This enclosure may for example be made of platinum and all of its alloys that are usually used in glass applications, such as for example with rhodium, or dispersions such as for example platinum dispersed with ZrO₂, or of iridium with corresponding alloys.

According to yet a further embodiment of the device for producing a glass product, in the region of the device within which the tube is arranged there is underneath the tube a bottom drain, which can be opened, so that the accumulated deposition of a defective glass can be drawn off, it being possible for the bottom drain and/or the tube to be arranged in any region of the device for producing a glass product and preferably being arranged in the region for hot forming.

By such a configuration, the content of troublesome constituents in the glass melt, such as for example defective glass, can be further reduced. By the general reduction of the content of defective glass, in a corresponding way the formation of knots in the resultant glass product is also reduced.

According to yet a further embodiment of the device for producing a glass product, the device is designed for the hot forming of a glass comprising tube drawing, for example by the Vello, Danner and/or draw-down process, or flat-glass hot forming, for example rolling or floating or drawing, such as for example drawing in a draw-down process or in an overflow-fusion process.

A further aspect of the present disclosure relates to a process for producing a glass product. The process comprises the steps of: melting, preferably fusing, a glass melt, in particular refining the glass melt, in particular conditioning the glass melt, hot forming the glass melt to obtain a glass product, at least one of the process steps being carried out in a device for producing a glass product which comprises a tube (R), which is designed for transferring the glass melt from one region of the device into another region, and the tube (R) being formed such that a part (r) of the tube (R) protrudes with a length (L) through a side wall (SW) of a region (S, L, K, H) into the glass melt (GS), the length (l) of the protruding part (r) being chosen such that the part (r) of the tube (R) protrudes into the region (S, L, K, H) to such an extent that little defective glass gets into the tube and is transferred into another region (S, L, K, H) of the device, the length (l) of the protruding part (r) of the tube (R) being preferably at least 25 mm, particularly preferably at least 50 mm and most particularly preferably at least as great as the average outside diameter of the tube cross section, and preferably being at most 500 mm, and the protruding part (r) of the tube (R) being at a distance from the inner base (TB) lying directly thereunder of the device in this region (S, L, K, H), by a distance (A) which is at least so great that little defective glass gets into the tube and is transferred into another region (S, L, K, H) of the device, the distance (A) preferably being at least 50 mm, and particularly preferably at least greater by a factor of 1.5 than the average outside diameter (a) of the tube cross section, the distance (A) preferably being at most the depth of the glass bath (SH) less 1.5 times the outside diameter of the tube cross section from the inner base of the region (S, L, K, H) of the device, so that in at least one of the process steps glass melt (GS) passes from at least one region (S, L, K, H) of the device through the tube (R) into another region (S, L, K, H) of the device.

According to an embodiment of the invention, the method may in particular be designed such it comprises the steps of melting, preferably fusing, a glass melt, in particular refining the glass melt, conditioning the glass melt, hot forming the glass melt to obtain a glass product, at least one of the process steps being carried out in a device for producing a glass product which comprises a tube, which is designed for transferring the glass melt from one region of the device into another region, and the tube being formed such that a part of the tube protrudes with a length through a side wall of a region of the device for conditioning into the glass melt, the length of the protruding part being chosen such that the part of the tube protrudes into the region of the device for conditioning to such an extent that little defective glass gets into the tube and is transferred into the region of the device for hot forming, the length of the protruding part of the tube being preferably at least 25 mm, particularly preferably at least 50 mm and most particularly preferably at least as great as the average outside diameter of the tube cross section, and preferably being at most 500 mm, and the protruding part of the tube being at a distance from the inner base lying directly thereunder of the device in the region of the device for conditioning, by a distance which is at least so great that little defective glass gets into the tube and is transferred into the region of the device for hot forming, the distance preferably being at least 50 mm, and particularly preferably at least greater by a factor of 1.5 than the average outside diameter of the tube cross section, the distance preferably being at most the depth of the glass bath less 1.5 times the outside diameter of the tube cross section from the inner base of the region of the device for conditioning, so that in at least one of the process steps glass melt passes from at least the first region of the device through the tube into the region of the device for hot forming.

Alternatively or additionally, the method may be designed such that it comprises the steps of melting, preferably fusing, a glass melt, in particular refining the glass melt, in particular conditioning the glass melt, hot forming the glass melt to obtain a glass product, at least one of the process steps being carried out in a device for producing a glass product which comprises a tube, which is designed for transferring the glass melt from one region of the device into another region, and the tube being formed such that a part of the tube protrudes with a length through a side wall of a region into the glass melt, the length of the protruding part being of the tube being at least 25 mm, preferably at least 50 mm and particularly preferably at least as great as the average outside diameter of the tube cross section, and preferably being at most 500 mm, and the protruding part of the tube being at a distance from the inner base lying directly thereunder of the device in this region, by a distance being at least 50 mm, and preferably at least greater by a factor of 1.5 than the average outside diameter of the tube cross section, the distance preferably being at most the depth of the glass bath less 1.5 times the outside diameter of the tube cross section from the inner base of the region of the device, so that in at least one of the process steps glass melt passes from at least one region of the device through the tube (R) into another region of the device.

As the maximum height, the tube may therefore lie below the line of the glass bath by half the outside diameter of the tube cross section.

Yet another aspect relates to a glass product that is preferably produced or can be produced in a process according to the present disclosure and/or in a device according to embodiments of the present disclosure, wherein the glass product is designed so that it comprises no knots with a diameter of more than 1.5 mm per pallet of glass, preferably no knots with a diameter of more than 1.2 mm per pallet of glass, more preferably no knots with a diameter of more than 1.0 mm per pallet of glass, particularly preferably no knots with a diameter of more than 0.9 mm per pallet of glass and most particularly preferably no knots with a diameter of more than 0.8 mm per pallet of glass the glass product comprising less than 3.4 knots per kilogram of glass with a diameter of more than 0.5 mm and at most 0.8 mm, preferably less than 3.3 knots per kilogram of glass, more preferably less than 3.2 knots per kilogram of glass and most particularly preferably less than 3 knots per kilogram of glass.

In the scope of the present disclosure, “a pallet of glass” is understood to refer to a pallet of glass products. The weight of the pallet of glass varies with the palletized glass product, but usually is in a range between about at least 900 kg and about at most 1100 kg, preferably between about 950 kg and about 1050 kg, that is about 1 t.

According to a further embodiment, the glass product is designed so that it comprises less than 3.4 knots per kilogram of glass with a diameter of more than 0.5 mm and at most 0.8 mm, preferably less than 3.3 knots per kilogram of glass, more preferably less than 3.2 knots per kilogram of glass and most particularly preferably less than 3 knots per kilogram of glass.

Within the scope of the present disclosure, the equivalent diameter is understood as the diameter of a particle like an inclusion in a melt.

In the process of forming glass, inclusions draw out, whereby normally a nucleus and pseudo-elliptic or striae-like shapes occur. If the diameter or average diameter or equivalent diameter, respectively, are referred to, in the scope of the present disclosure, the specification of that dimension refers to the nucleus, therefore without taking into consideration the pseudo-elliptic or striae-like shapes surrounding the nucleus.

The glass product according to embodiments of the present disclosure can be a glass rod or a glass tube, for example.

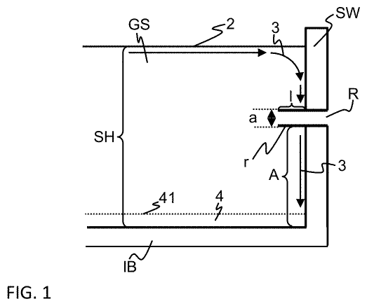

Referring now to the drawings and in particular to FIG. 1, a schematic representation of a part of a device 1 for producing a glass product according to one embodiment is shown. Shown is a part of a device 1, in which a glass melt GS is present. This has a glass level 2, which is indicative of the height SH of the glass melt GS in the device 1. The glass melt GS exhibits a convection flow 3, which in the present case is represented in FIG. 1 schematically in the form of arrows, which show the direction of convection in the glass melt GS. The device 1 has a side wall SW, in which a transfer device in the form of a tube R is arranged. Through the transfer device formed as a tube R, glass melt GS can be transferred from one region of the device 1 into another region (not represented) of the device 1.

The tube R is formed such that a part r of the tube R protrudes through the side wall SW of a region of the device 1 into the glass melt GS. The length l of the protruding part r is chosen such that the part r of the tube R protrudes into the region to such an extent that little defective glass gets into the tube R and is transferred into another region of the device 1. Advantageously, the length l of the protruding part r of the tube R is at least 25 mm, preferably at least 50 mm and is particularly preferably at least as great as the average outside diameter a of the tube cross section. Preferably, the length l of the part r of the tube R is at most 500 mm. For better illustration, here the part r is shown as very long in comparison with the overall length of the tube R. As stated above, this is however only a schematic representation.

It can also be seen from FIG. 1 that the part r of the tube R is at a distance from the inner base IB lying directly thereunder of the device 1 in this region, by a distance A. This distance A is at least so great that little defective glass gets into the tube R and is transferred into another region of the device 1. Preferably, the distance A is at least 50 mm and particularly preferably at least greater by a factor of 1.5 than the average outside diameter a of the cross section of the tube R, the distance A particularly preferably being at most the depth of the glass bath T less 1.5 times the outside diameter a of the tube cross section, measured from the inner base IB of the respective region of the device 1.

Such a distance A is advantageous to ensure that the tube is arranged higher than the level 41 of the bottom layer 4. This is so because the bottom layer 4 comprises a deposition, that is to say comprises for example defective glass. The distance A should therefore be chosen to be so great that it lies above the level 41 of the bottom layer 4.

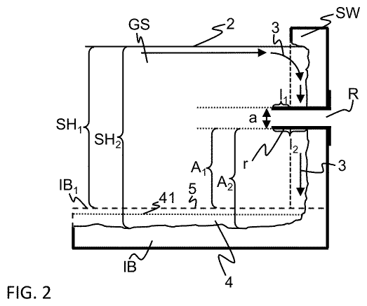

FIG. 2 shows in a schematic and not-to-scale representation a part of a device 1 according to a further embodiment. Shown here is a part of a device 1 in which the walls of the device comprising refractory material, for example the side wall SW, have already been exposed to a certain corrosion. As a consequence, the thickness of the side wall SW in the region underneath the glass level 2 has decreased. Also shown is the original level 5 of the inner base. However, this original level of the inner base has been eroded by the refractory corrosion and the inner base IB of the device 1 now lies deeper in the region represented here.

The refractory corrosion has the consequence for the device 1, part of which is shown here, that the tube R formed as a transfer device now protrudes further into the glass melt GS than was the case before the refractory corrosion. In this case, therefore, the tube R can be characterized as follows:

It has a part r, which protrudes into the glass melt GS in a region of the device 1. When the tube R is installed, the length of the part r assumes the value I₁. After a certain time after installation, the length of the part r assumes the value I₂, where I₂ is greater than I₁. The tube R is configured here such that it corrodes less badly than the side wall SW, or not at all, for example in that the tube R is enclosed, preferably completely, with a noble metal. Complete enclosure should be understood as meaning such an enclosure in which the enclosure only comprises a small pressure-equalizing opening. This makes up less than 0.1% of the overall surface of the tube R and is always on the face of the tube R that is away from the glass.

The device 1 is characterized furthermore in the region represented here by the distance A₁ at the time of installation of the tube R. This distance A₁ is determined by the level 5 of the inner base at the time of installation. The inner base IB now lies deeper here due to the refractory corrosion, so that now the distance A₂ is of significance. This distance A₂ is schematically represented here and can be understood as the distance that the tube is from the average level of the inner base IB, which is formed by refractory corrosion. This is so because, as schematically represented here, the refractory corrosion does not lead to a uniform removal of the refractory material, but instead an irregular surface of the inner base IB may form. Also schematically represented here is the original level 5 of the inner base.

The glass melt GS in the region represented here of the device can consequently also be characterized furthermore by a melt bath height SH₁ at the time of installation of the tube and by a melt bath height SH₂ at a time after installation, at which a certain corrosion of the refractory material has already taken place. The melt bath height SH₂ is greater than the melt bath height SH₁, since the original level 5 of the inner base lies higher than the level (not indicated) of the inner base IB after corrosion of the device.

Here, the tube R is configured furthermore such that it has a collar 61, which is arranged on the outer side of the side wall SW. Preferably, this collar is formed from the material of the enclosure (not indicated here).

Also indicated are the convection flow 3 and the glass level 2 as well as the level 41 of the bottom layer 4, the level 41 of the bottom layer 4 lying below the level 5 of the inner base IB. This is therefore the level 41 of the bottom layer 4 when corrosion has already taken place. The level of the bottom layer before corrosion has taken place is not shown here.

The tube R is formed such that at any point in time a part r of the tube R is protruding into a region of the device 1. That is to say that it is not just after corrosion of the refractory material that it protrudes into it, but rather that the tube R is deliberately formed such that it is longer than the side wall SW is thick at the time of installation.

Also the distance A₁ is chosen such that at any point in time it lies above the level 41 of the bottom layer 4, not just after the lowering of the level 5 of the inner base IB.

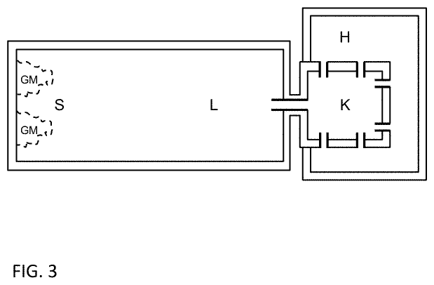

FIG. 3 shows a further schematic and not-to-scale device 1 according to one embodiment. The device 1 can be seen here in a schematic view from above, that is to say in a plan view. The device 1 for producing a glass product comprises here a region S for melting a glass melt. A charged batch GM, which at least partially has not yet fully melted, can be seen in the region S. The region S goes over to the right into the region L for refining the glass melt GS (not indicated here). The region S and the region L of the device 1 are not structurally separated here, but go over one into the other. Also shown is the region K for conditioning the glass melt GS, not indicated here, and the region H for hot forming.

Here the device 1 comprises furthermore at least one transfer device, which is formed as a tube R and by which the glass melt can be transferred from one region, here the region L, into another region, here the region K. In addition to this first transfer device, formed as a tube R, the device 1 comprises further transfer devices which are formed as a tube R and by which the glass melt can in each case be transferred from one region, here the region K, into another region, here the region H for hot forming.

The tube R is formed here in each case such that a part r of the tube R protrudes through a side wall SW of a region, here the region L or the region K, into the respective region S, K. The length l of the protruding part r is chosen such that the part r of the tube R in each case protrudes into the respective region, here the regions S and K, to such an extent that little defective glass gets into the tube R and is transferred into another region, here the region K or H, the length l of the protruding part r of the tube R preferably being at least 25 mm, particularly preferably at least 50 mm, and most particularly preferably at least as great as the average outside diameter a (not indicated) of the tube cross section. The length l is preferably at most 500 mm.

Furthermore, the protruding part r of the tube R is at a distance from the inner base (not indicated) lying directly thereunder of the device in the respective region, here the region L or K, by a distance A (not indicated) which is at least so great that little defective glass gets into the tube R and is transferred into another region, here the region K or H, of the device 1, the distance A preferably being at least 50 mm, and particularly preferably at least greater by a factor of 1.5 than the average outside diameter a (not indicated here) of the tube cross section, the distance A particularly preferably being at most the depth of the glass bath in this region less 1.5 times the outside diameter a of the tube cross section from the inner base of the corresponding region, that is to say here the region L or K.

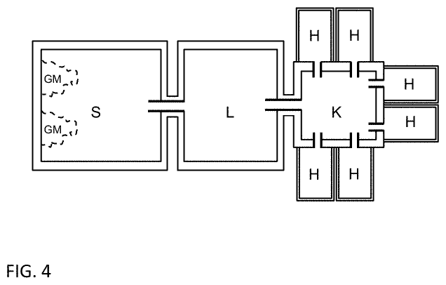

FIG. 4 shows a further schematic and not-to-scale representation of a device 1 according to one embodiment. The regions S, L, K and H are represented in a schematic plan view of the device 1. Here, the region S and the region L of the device 1 are structurally separated and connected to one another by a transfer device configured as a tube R in such a way that the glass melt GS (not indicated) can be transferred from the region S into the region L by the transfer device configured as a tube R. Here, the device 1 comprises furthermore still further transfer devices which are configured as a tube R and by which glass melt can be transferred from the region L into the region K or from the region K into the region H. The device 1 is configured here such that it comprises a number of regions H, each region H being respectively assigned a transfer device configured as a tube R. In the region on the left of the device, a charged and at least partially not yet melted batch GM is likewise schematically shown.

Generally, however, it is also possible that the device 1 comprises only one region H, as also shown by way of example in FIG. 3, it being possible for a number of transfer devices configured as a tube R to be arranged between the region K and the region H, so that glass melt can be transferred from a region K into a region H by a number of transfer devices configured as a tube R.

In the device 1 schematically represented here it is possible by way of example that a region H is configured such that a tube drawing, for example a tube drawing by the Danner process or by the Vello process, is performed, and another region H is configured such that a flat-glass hot forming is then performed here. However, it is also possible that all of the regions are designed such that a flat-glass hot forming or a tube drawing is in each case performed.

The transfer device configured as a tube R is configured here in each case such that a part r of the tube R protrudes through a side wall (not indicated here) into the respective region, here the region S, L or K, into the glass melt. The length l of the protruding part r of the tube R is in each case chosen such that the part r of the tube R protrudes into the respective region S, L or K to such an extent that little defective glass gets into the tube R and is transferred into another region, here the region L, K or H, of the device 1. The length l of the protruding part r of the tube R is in each case preferably at least 25 mm, particularly preferably at least 50 mm, and most particularly preferably at least as great as the average outside diameter a (not indicated here) of the tube cross section, and is preferably at most 500 mm. Furthermore, the protruding part r of the tube R is at a distance from the inner base IB (not indicated here) lying directly thereunder of the respective region, here the region S, L or K, by a distance A (likewise not indicated here) which is at least so great that little defective glass gets into the tube R and is transferred into another region, here the region or regions L, K, H, of the device 1, the distance A preferably being at least 50 mm, and particularly preferably at least greater by a factor of 1.5 than the average outside diameter a of the tube cross section, the distance A preferably being at most the depth of the glass bath less 1.5 times the outside diameter a of the tube cross section from the inner base of the respective region, here the regions S, L, K.

According to a further embodiment of the device 1, the tube R is arranged in a side wall of the device 1 between the region L for refining and the region K for conditioning, the part r of the tube protruding into the region L for refining, so that glass melt is transferred or can be transferred from the region L for refining into the region K for conditioning. The protruding part r of the tube R thereby protrudes through the side wall into the region L.

As an alternative or in addition, the device 1 according to this embodiment may be configured such that the tube R is arranged in a side wall of the device 1 between the region K for conditioning and one or more regions H for hot forming the glass melt, a part r of the tube R protruding into the region K for conditioning, so that glass melt is transferred or can be transferred from the region K for conditioning into the region or the regions H for hot forming, the protruding part r of the tube R protruding through the side wall into the region K.

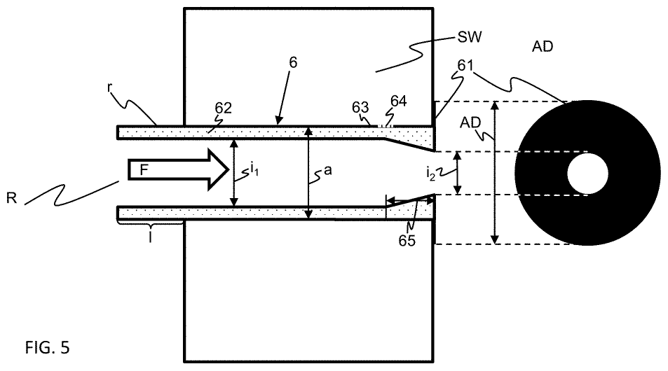

FIG. 5 shows a schematic and not-to-scale representation of a transfer device configured as a tube R according to one embodiment. The tube R is formed here such that the inner diameter i of the tube cross section tapers in the direction of flow F of the glass melt (not indicated). The tube can therefore be described by the maximum inner diameter i₁, which corresponds to the inner diameter of the tube cross section in the non-tapering part of the tube, and by the minimum inside diameter i₂. For the case of a tube with an approximately round inner cross section, the tapering of the tube takes place for example in such a way as to form a truncated cone or a cone, which can be described by the length 65 as well as the inner diameter i₁ and the inner diameter i₂.

The tube R is formed here such that it has an approximately round tube cross section. The tube is formed here such that it comprises a first material 62 and a second material 63. The first material 62 may be a refractory material, for example comprising zirconia and/or SiO₂ and/or MgO, and/or a refractory metal. The second material 63 forms the enclosure 6 here, i.e. the second material 63 therefore encloses the first material 62 of the tube R completely here, where complete enclosure should be understood as meaning such an enclosure in which there is just a small opening 64 for pressure equalization in the enclosure 6. The second material 63 preferably comprises a noble metal, such as for example platinum, or at least partially or even completely consists of a noble metal, such as for example platinum, or of a noble metal alloy. The enclosure 6 forms on the side of the side wall SW that is facing away from the region of the device into which the part r of the tube R protrudes a collar 61, which lies against the outer side of the side wall S. Furthermore, the enclosure 6 has a pressure-equalizing opening 64.

Here, therefore, the tube R is enclosed with a material 63, which is preferably formed as a material comprising noble metal or at least partially consists of a noble metal and also may be formed completely from a noble metal or an alloy of a noble metal. Generally, without being restricted to the example depicted here of a tube R, it may also be however that only the part of the tube R that is in direct contact with the glass melt is covered with a material 63. Here, this would be the inner wall of the tube R, the region of the end faces of the tube R and the part r of the tube that protrudes into the glass melt.

Here, the enclosure 6 comprises furthermore a pressure-equalizing opening 64.

A specific embodiment is described below in order to illustrate the invention further:

According to one embodiment, it is possible that the side wall SW has for example a thickness of 300 mm, here this thickness being the starting thickness, that is to say before a possible corrosion of the side wall SW by the glass melt GS. The tube R may have an overall length of 470 mm. Consequently, here the length l of the part r of the tube R would be 170 mm. This length l should be understood as meaning the length l₁, that is to say the length at the time of installation of the tube R. Here, this length l or l₁ is therefore at least as great as the average outside diameter a of the tube cross section, to be specific at least 160 mm, and furthermore is greater here than 160 mm, to be specific 170 mm long. The tube R is configured here as approximately round, and can therefore be described by an inside diameter i₁ of 130 mm and an outside diameter a of 160 mm. Here, the inside diameter i₁ is the greatest inside diameter of the tube cross section. As also schematically represented in FIG. 5, the tube has a tapering region, which has a frustoconical shape. This tapering region is therefore also often referred to as a cone. The length 65 of the cone of the tube R may be for example 30 mm. The inside diameter i₂ as a minimum inside diameter may be 120 mm.

The tube R is enclosed, for which purpose for example the enclosure 6 may be formed from the material 63, for example from an alloy comprising 90% by weight platinum and 10% by weight rhodium. In the region of the body of the tube, the material 63 may for example be formed by a metal sheet with a thickness of 0.7 mm. The collar 61 may likewise be formed by such a metal sheet, in particular with the same thickness as the enclosure 6 has in the region of the body of the tube R. However, it is also possible that the material 63 in the region of the collar has a different, for example greater, thickness than in the region of the body of the tube, for example a thickness of 1 mm. As schematically shown here, the collar 61 may be formed for example as a disc, which may for example have an outside diameter AD, here of 260 mm, the inside diameter of the disc corresponding to the inside diameter i₂ of the tube cross section.

For a tube with an outside diameter a of 160 mm, it is advantageous if the bore through the side wall SW has a diameter of between 164 mm and 166 mm. This makes allowance for the production tolerances of the tube R and furthermore also takes into account the influence of the enclosure 6.

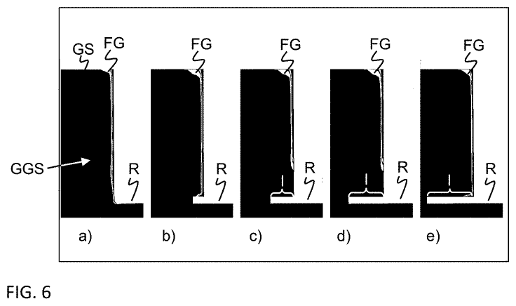

FIG. 6 shows in a diagrammatic representation a part of a device 1 for producing a glass product comprising a transfer device, by which the glass melt GS is transferred or can be transferred from one region of the device into another region (not shown). The part of the device 1 is shown here five times, the devices 1 respectively differing here by the length l of the protruding part r of the tube, of which only the upper part is represented.

It is diagrammatically indicated here that the glass melt GS comprises both base glass melt GGS (good glass) and defective glass FG. For the sake of overall clarity, glass melt GS and good glass melt GGS are only indicated in part a) of FIG. 6.

If, as in part a) of FIG. 6, no part r (not indicated here) of the tube R protrudes into the glass melt, defective glass FG can get directly into the transfer device formed as tube R. In part b) of FIG. 6, the protrusion is 25 mm and shows the minimum limit for a sufficient protrusion. For the sake of overall clarity, the length l is not indicated here.

In parts c) and d) of FIG. 6, there is a protrusion of the part r (not indicated here) that is definitely sufficient at least to reduce the ingress of defective glass FG into the tube. The defective glass flow ends here above the tube. This is so because the protrusion of the tube R leads locally to a change in the convection flows. However, it may happen here that a new turbulent flow results in corrosion, to be specific at the transition between tube and side wall. In part c), the protrusion is 50 mm, that is to say the length of the part r is 50 mm, and in part d) it is 75 mm.

If, as schematically represented in part e) of FIG. 6, the length l of the part r is increased further, such a corrosion by turbulent flow could possibly be prevented. In part e), the length of the part r is 100 mm.

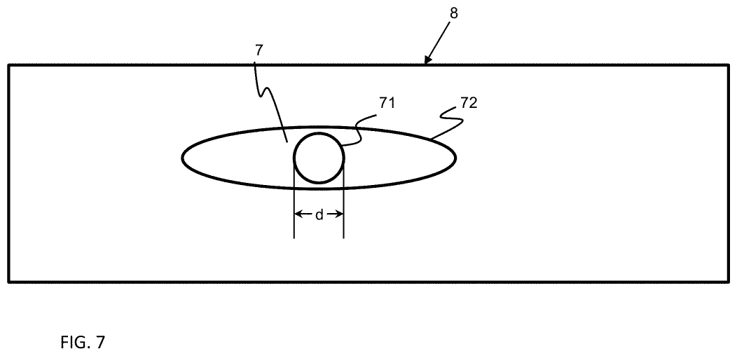

Finally, FIG. 7 shows a schematic and not-to-scale presentation of a knot 7 in a glass product 8 which may for example be designed as a glass tube, for illustrating the average diameter. Here, the diameter d is described as equivalent diameter, wherein the equivalent diameter d is here given as volume equivalent diameter. FIG. 7 schematically shows a part of a glass product 8 comprising an inclusion, here a knot 7. That knot 7 has a nucleus 71 which may be described using a diameter d, for example the so-called equivalent diameter, and which here is almost spherical. Furthermore, the knot 7 comprises pseudo-elliptic or striae-like shapes 72 surrounding the nucleus 71 of knot 7. These pseudo-elliptic or striae-like shapes 72 are not taken into account in regard to diameter d, as for example the average diameter or the equivalent diameter of knot 7.

If therefore, the diameter of a knot 7 is referred to within the scope of the present disclosure; it is the diameter of nucleus 71.

### LIST OF REFERENCE NUMERALS

1 Device for producing a glass product

2 Glass level

3 Convection flow

4 Bottom layer

41 Level of the bottom layer

5 Original level of the inner base

6 Enclosure

61 Collar

62 First material

63 Second material, material of the enclosure

64 Pressure-equalizing opening in the enclosure 6

65 Length of cone

7 Knot

71 Nucleus of the knot

72 pseudo-elliptic or striae-like shapes of the knot

R Tube

8 Glass product

d Diameter of the knot (or of the nucleus of the knot, respectively)

r Part of the tube protruding into glass melt

l Length of the protruding part

l₁ Length of the protruding part when the tube is installed

l₂ Length of the protruding part after corrosion of the refractory material has taken place

a Average outside diameter of the tube

A Distance of the tube from the inner base

A₁ Distance of the tube from the inner base when the tube is installed

A₂ Distance of the tube from the inner base after corrosion of the refractory material has taken place

SH Height of the melt bath

SH₁ Height of the melt bath at the time of installation of the tube

SH₂ Height of the melt bath after corrosion of the refractory material has taken place

GM Batch

GS Glass melt

SW Side wall

IB Inner base

S Region for melting

L Region for refining

K Region for conditioning

H Region for hot forming

i Inner radius of the tube

i₁ Maximum inner radius of the tube

i₂ Minimum inner radius of the tube

GGS Good glass melt

FG Defective glass

AD Outside diameter of the collar

What is claimed is:

1. A method for producing a glass product, comprising the steps of:
providing a glass melt;
hot forming the glass melt to obtain a glass product; and
transferring the glass melt from a first region to a second region through a tube, the tube having a part that protrudes with a length into the glass melt in the first region, the part being at a distance from an inner base lying directly thereunder, wherein the length and the distance are configured so that little defective glass gets into the tube and is transferred to the second region.

2. The method of claim 1, further comprising transferring the glass melt from the second region to a third region through another tube having a part that protrudes with a length into the glass melt in the second region, the part being at a distance from an inner base lying directly thereunder, wherein the length and the distance are configured so that little defective glass gets into the tube and is transferred to the third region.

3. The method of claim 2, further comprising transferring the glass melt from the third region to a fourth region through yet another tube having a part that protrudes with a length into the glass melt in the third region, the part being at a distance from an inner base lying directly thereunder, wherein the length and the distance are configured so that little defective glass gets into the tube and is transferred to the fourth region.

4. The method of claim 1, wherein the step of providing the glass melt comprises a step selected from a group consisting of melting, fusing, refining, conditioning, and any combinations thereof.

5. The method of claim 1, wherein the step of providing the glass melt comprises melting and/or fusing the glass melt in the first region.

6. The method of claim 5, wherein the second region is a region configured to treat the glass melt by a process selected from a group consisting of refining, conditioning, the step of hot forming, and any combination thereof.

7. The method of claim 1, wherein the step of providing the glass melt comprises refining in the first region.

8. The method of claim 7, wherein the second region is a region configured to treat the glass melt by a process selected from a group consisting of conditioning, the step of hot forming, and any combination thereof.

9. The method of claim 1, wherein the second region is a region for the step of hot forming.

10. The method of claim 1, further comprising drawing off an accumulated deposition of the defective glass from the glass melt from a drain in the inner base, the drain being underneath the part.

11. The method of claim 1, wherein the step of hot forming the glass melt to obtain the glass product comprises drawing a glass rod or glass tube using a process selected from a group consisting of a Vello process, a Danner process, and a draw-down process.

12. The method of claim 1, further comprising configuring the length of the part to be at least 25 mm.

13. The method of claim 1, further comprising configuring the length of the part to be at least as great as an average outside diameter of a cross section of the tube.

14. The method of claim 1, further comprising configuring the length of the part to be at most 500 mm.

15. The method of claim 1, further comprising configuring the distance to be at least 50 mm.

16. The method of claim 1, further comprising configuring the distance to be at least greater by a factor of 1.5 than an average outside diameter of a cross section of the tube.

17. The method of claim 1, further comprising configuring the distance to be at most a depth of a bath of the glass melt less 1.5 times an outside diameter of a cross section of the tube.

18. The method of claim 1, further comprising configuring the tube so that an average inside diameter tapers in a direction of flow of the glass melt from the first region to the second region.

19. The method of claim 1, further comprising configuring the tube as a refractory material and/or a refractory metal at least in an area that is in direct contact with the glass melt.

20. The method of claim 1, wherein the transferring through the tube is sufficient so that the glass product comprises no knots with a diameter of more than 1.5 mm per pallet of glass.

21. The method of claim 1, wherein the transferring through the tube is sufficient so that the glass product comprises no knots with a diameter of more than 0.8 mm per pallet of glass.

22. The method of claim 1, wherein the transferring through the tube is sufficient so that the glass product comprises less than 3.4 knots per kilogram of glass with a diameter of more than 0.5 mm and at most 0.8 mm.

23. The method of claim 1, wherein the transferring through the tube is sufficient so that the glass product comprises less than 3 knots per kilogram of glass with a diameter of more than 0.5 mm and at most 0.8 mm.
